(19) United States
(12) Patent Application Publication
(10) Pub. No.: US 2022/0382268 A1
(43) Pub. Date: Dec. 1, 2022

(54) ENVIRONMENTAL CONTROL SYSTEM DIAGNOSTICS AND OPTIMIZATIONS USING INTELLIGENT LIGHTING NETWORKS

(71) Applicant: IDEAL Industries Lighting LLC, Racine, WI (US)

(72) Inventors: Amruteshwar Hiremath, Cary, NC (US); Kory Alexander Liszt, Apex, NC (US)

(21) Appl. No.: 17/332,385

(22) Filed: May 27, 2021

(51) Int. Cl. G05B 23/02; G01K 1/024; F24F 11/63

(52) U.S. Cl. CPC G05B 23/0221; G01K 1/024; F24F 11/63

(57) ABSTRACT

Environmental control system diagnostics and optimizations using intelligent lighting networks are provided. One or more intelligent lighting modules (ILMs) can be deployed in intelligent lighting fixtures, intelligent lighting zone controllers, and other intelligent lighting network devices to collect ambient environmental data (e.g., temperature, pressure, and humidity) in addition to occupancy and ambient light sensing used for lighting control. In this manner, embodiments of the present disclosure address diagnostics and improve performance of environmental control systems (e.g., heating ventilation and air conditioning (HVAC) systems) by offering a secondary set of sensors for HVAC systems at a lower cost than traditional approaches. In particular, the ILMs or other processing circuitry in communication with the ILMs analyze the collected ambient environmental data to diagnose the health and function of the environmental control system, and communicate the diagnoses to users and/or the HVAC system.

### FIELD OF THE DISCLOSURE

The present disclosure relates to environmental control system diagnostics in lighting systems.

### BACKGROUND

Heating ventilation and air conditioning (HVAC) systems have been around for over a century. HVAC systems are an absolute need in this era, and they are generally reliable in a well-designed building. However, in less well-designed set-ups/buildings or due to improper maintenance or other factors, HVAC systems can malfunction or cease functioning. Because an HVAC system includes numerous mechanical moving parts, such failures often occur without any warning. There are many add-on products over basic HVAC systems that can detect system abnormalities or issue warnings to building maintenance personnel. These products are offered by HVAC companies or third-party companies and come at a premium price, particularly in large-scale HVAC systems.

All HVAC systems rely on sensors which are strategically placed across a building to obtain temperature data (and in many systems humidity data) and run the control algorithms to perform HVAC functions. These sensors directly reporting to HVAC systems are primary sensors. For practical reasons, there are limitations on how many sensors a system can have for effective and uniform HVAC performance. However, this limited sensor placement can result in certain areas of buildings being too cold or too warm leading to dissatisfaction with HVAC performance.

### SUMMARY

Environmental control system diagnostics and optimizations using intelligent lighting networks are provided. One or more intelligent lighting modules (ILMs) can be deployed in intelligent lighting fixtures, intelligent lighting zone controllers, and other intelligent lighting network devices to collect ambient environmental data (e.g., temperature, pressure, and humidity) in addition to occupancy and ambient light sensing used for lighting control. In this manner, embodiments of the present disclosure address diagnostics and improve performance of environmental control systems (e.g., heating ventilation and air conditioning (HVAC) systems) by offering a secondary set of sensors for HVAC systems at a lower cost than traditional approaches. In particular, the ILMs or other processing circuitry in communication with the ILMs analyze the collected ambient environmental data to diagnose the health and function of the environmental control system, and communicate the diagnoses to users and/or the HVAC system.

In another aspect, ILMs can be deployed in controlled environments (e.g., clean rooms) to monitor differential environmental measurements, such as differential air pressure. Controlled environments often have stringent requirements for control of ambient conditions and can require frequent monitoring to ensure the requirements are met. For example, clean rooms across medical, pharmaceutical, research, and industrial facilities are required to maintain a certain amount of positive pressure or negative pressure. Such facilities may need to frequently verify that pressures in the clean rooms are within expected range and often use hand-held visual pressure gauges to monitor current pressure levels inside and outside of clean rooms. Even a smaller facility may have several clean rooms and each one needs to be monitored on a very regular basis, which results in a great deal of manual labor, time and cost, while potentially introducing human error. Embodiments can deploy advanced light fixtures with integrated environmental sensor(s) (e.g., ILMs) to constantly monitor pressure in clean rooms and common areas to report any anomalies. Such embodiments greatly reduce manual labor, cost, and time for monitoring conditions, and can additionally reduce human errors.

An exemplary embodiment provides a method for providing diagnostic information for an environmental control system using a lighting network. The method includes collecting ambient environmental data from an ILM in the lighting network and performing a diagnostic of the environmental control system based on the ambient environmental data.

Another exemplary embodiment provides a lighting system. The lighting system includes a lighting fixture, an ILM comprising an environmental sensor, and a processing device in communication with the ILM. The processing device is configured to receive environmental data from the environmental sensor and analyze the environmental data to diagnose a potential failure of an environmental control system.

Another exemplary embodiment provides an ILM for a lighting fixture that has a light source that outputs light for general illumination. The ILM includes an environmental sensor configured to detect at least one of temperature data, pressure data, or humidity data. The ILM further includes processing circuitry configured to analyze at least one of the temperature data, the pressure data, or the humidity data to provide a diagnostic of an environmental control system. The ILM further includes communications circuitry configured to send the diagnostic of the environmental control system to another device.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of an intelligent lighting network according to one embodiment of the present disclosure.

FIG. 2A is a block diagram illustrating details of an intelligent lighting module (ILM) according to one embodiment of the present disclosure.

FIG. 2B is a schematic diagram of an exemplary embodiment of the ILM.

FIG. 2C is a schematic diagram of another exemplary embodiment of the ILM.

FIG. 2D is a schematic diagram of another exemplary embodiment of the ILM.

FIG. 3A is a schematic diagram of an exemplary installation of the ILM in a lighting fixture.

FIG. 3B is a cross-sectional schematic diagram of the lighting fixture of FIG. 3A.

FIG. 3C is a block diagram illustrating details of the ILM according to another embodiment of the present disclosure.

FIG. 4A is a graphical representation of an example of temperature and relative humidity cycles collected by an ILM in a closed room.

FIG. 4B is a graphical representation of a fast Fourier transform (FFT) of the indoor temperature data of FIG. 4A.

FIG. 5A is a graphical representation of an example of indoor temperature cycle durations on a relatively warmer winter day.

FIG. 5B is a graphical representation of another example of indoor temperature cycle durations on a different winter day.

FIG. 5C is a graphical representation of another example of indoor temperature cycle durations on a relatively colder winter day.

FIG. 6A is a graphical representation of an example of very long temperature cycles, indicating an undersized environmental control system.

FIG. 6B is a graphical representation of another example of long temperature cycles even in more favorable conditions in the same space as FIG. 6A.

FIG. 7A is a graphical representation of an example of short temperature cycles, indicating a non-optimal environmental control system.

FIG. 7B is a graphical representation of an example of relatively reasonable temperature cycles, indicating acceptable environmental control system behavior.

FIG. 8A is a schematic diagram of an example environment where environmental data is collected using ILMs in lighting fixtures A-R.

FIG. 8B is a graphical representation of pressures in the common area and room RM₁ in the environment of FIG. 8A.

FIG. 9A is a graphical representation of temperature data gathered from an ILM installed in a lighting fixture compared with ambient temperature gathered from outside the lighting fixture.

FIG. 9B is a graphical representation of relative humidity data gathered from the ILM of FIG. 9A compared with ambient relative humidity data gathered from outside the lighting fixture.

FIGS. 10A and 10B together are a flow diagram illustrating a process for environmental control system diagnostics and optimization according to embodiments described herein.

FIG. 11A is a schematic diagram of an exemplary controlled environment where environmental measurements are collected within and without the controlled environment using ILMs in lighting fixtures A, F, G, H, and K.

FIG. 11B is a graphical representation of pressures in the common area and room RM₁ in the environment of FIG. 11A.

FIG. 11C is a graphical representation of atmospheric pressure measurements as a function of altitude.

FIG. 11D is a graphical representation of atmospheric pressure measurements for three ILMs at different mounting heights in a room.

FIG. 12 is a flow diagram illustrating a process for monitoring differential measurements in a controlled environment using a lighting network.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Environmental control system diagnostics and optimizations using intelligent lighting networks are provided. One or more intelligent lighting modules (ILMs) can be deployed in intelligent lighting fixtures, intelligent lighting zone controllers, and other intelligent lighting network devices to collect ambient environmental data (e.g., temperature, pressure, and humidity) in addition to occupancy and ambient light sensing used for lighting control. In this manner, embodiments of the present disclosure address diagnostics and improve performance of environmental control systems (e.g., heating ventilation and air conditioning (HVAC) systems) by offering a secondary set of sensors for HVAC systems at a lower cost than traditional approaches. In particular, the ILMs or other processing circuitry in communication with the ILMs analyze the collected ambient environmental data to diagnose the health and function of the environmental control system, and communicate the diagnoses to users and/or the HVAC system.

In another aspect, ILMs can be deployed in controlled environments (e.g., clean rooms) to monitor differential environmental measurements, such as differential air pressure. Controlled environments often have stringent requirements for control of ambient conditions and can require frequent monitoring to ensure the requirements are met. For example, clean rooms across medical, pharmaceutical, research, and industrial facilities are required to maintain a certain amount of positive pressure or negative pressure. Such facilities may need to frequently verify that pressures in the clean rooms are within expected range and often use hand-held visual pressure gauges to monitor current pressure levels inside and outside of clean rooms. Even a smaller facility may have several clean rooms and each one needs to be monitored on a very regular basis, which results in a great deal of manual labor, time and cost, while potentially introducing human error. Embodiments can deploy advanced light fixtures with integrated environmental sensor(s) (e.g., ILMs) to constantly monitor pressure in clean rooms and common areas to report any anomalies. Such embodiments greatly reduce manual labor, cost, and time for monitoring conditions, and can additionally reduce human errors.

I. Intelligent Lighting Network and Devices

A. Intelligent Lighting Network

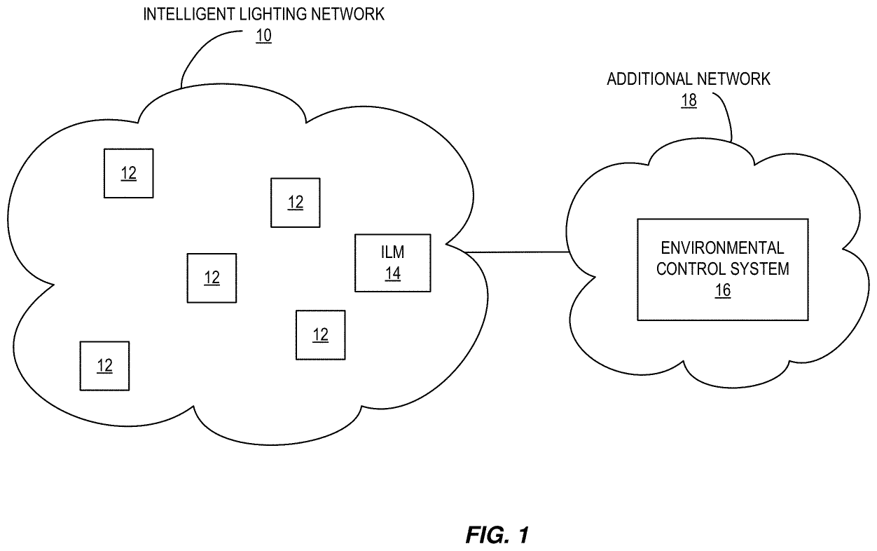

FIG. 1 is a schematic diagram of an intelligent lighting network 10 according to one embodiment of the present disclosure. The intelligent lighting network 10 includes one or more lighting fixtures 12 and one or more intelligent lighting modules (ILMs) 14. As described in greater detail below, an ILM 14 according to embodiments described herein includes one or more environmental sensors which collect ambient environmental data. The ILM 14 includes or is coupled to processing circuitry which analyzes the ambient environmental data to perform a diagnostic of an environmental control system 16 (e.g., an HVAC system).

The intelligent lighting network 10 may be a mesh network such as one based on the IEEE 802.15.4 standard, Bluetooth, WiFi, etc. The ILM 14 may also be part of or in communication with an additional network 18 such as a TCP/IP network (e.g., via ethernet, WiFi, or any other suitable connection mechanism). Accordingly, the ILM 14 may provide gateway functionality to bridge communication between the intelligent lighting network 10 and the additional network 18. In some examples, the ILM 14 may be coupled to another device, such as an intelligent lighting coordinator, which provides such gateway functionality between the intelligent lighting network 10 and the additional network 18. The environmental control system 16 may connect to the ILM 14 via the additional network 18 in order to receive the diagnostic, receive at least some of the environmental data, and/or provide control information (e.g., a set-point, a duration, etc. of an environmental control scheme) to the ILM 14. In some examples, the environmental control system 16 includes a software application running on a computing device such as a smartphone, a tablet, a computer, or the like.

B. Intelligent Lighting Modules (ILMs)

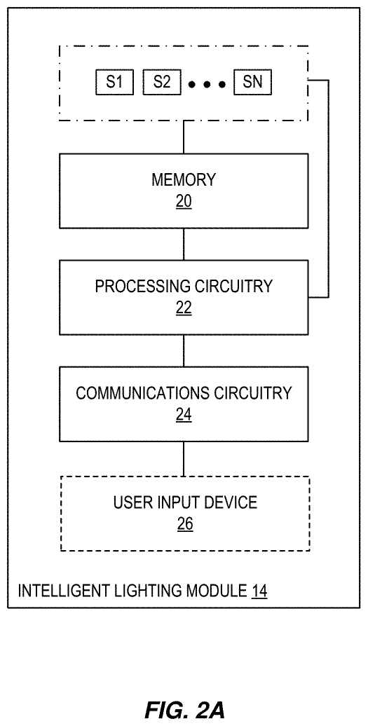

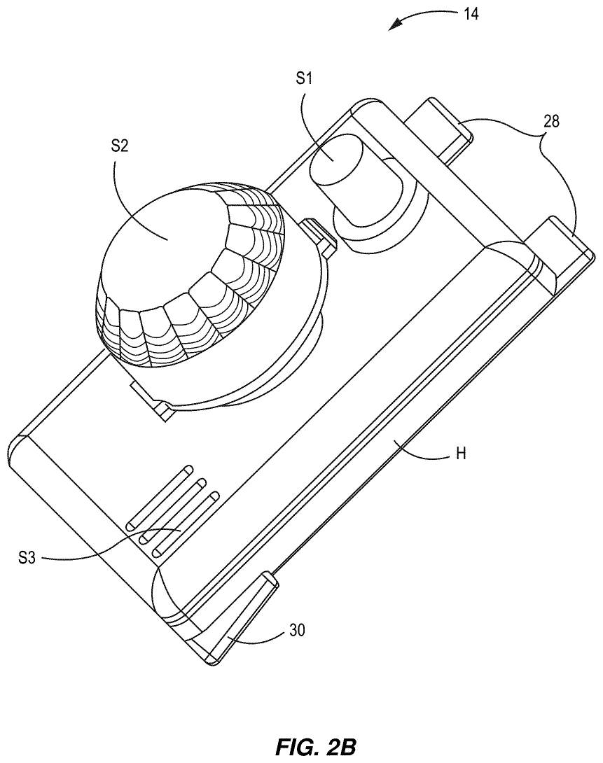

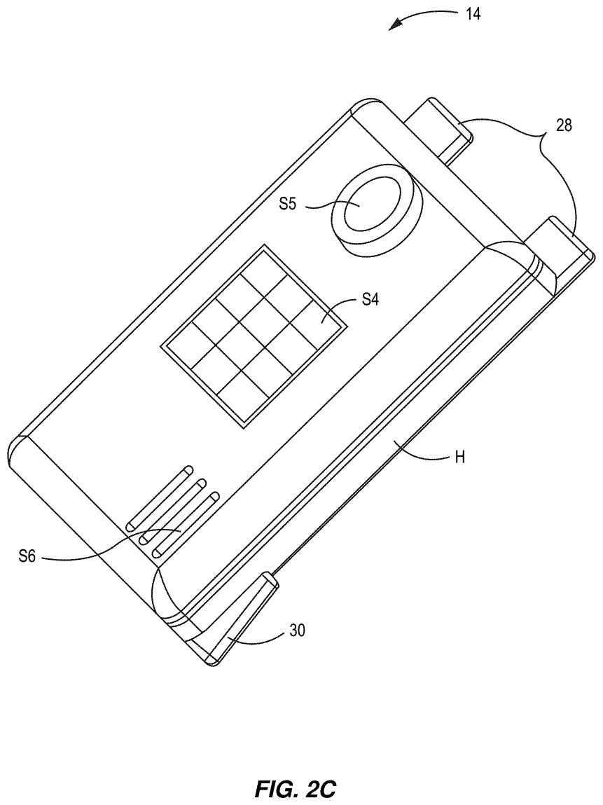

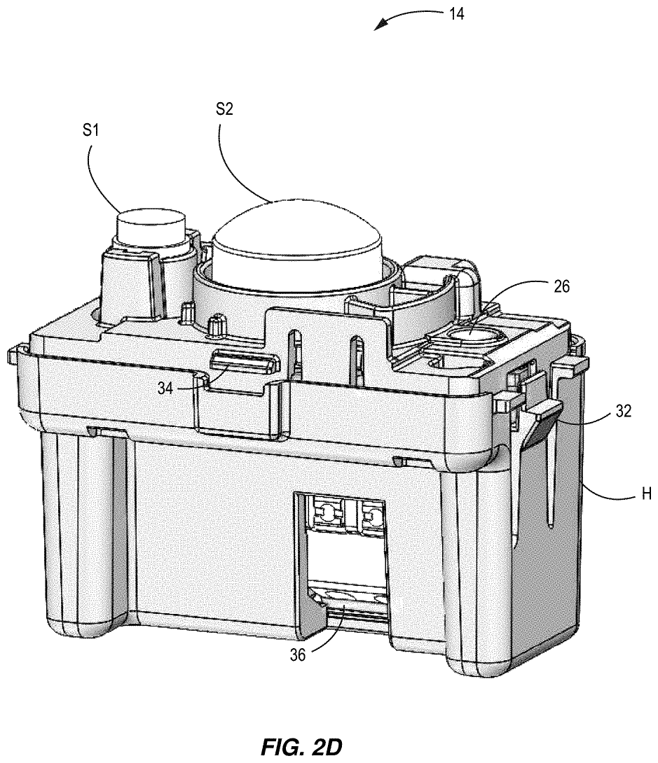

FIG. 2A is a block diagram illustrating details of the ILM 14 according to one embodiment of the present disclosure. The ILM 14 includes one or more sensors S1-SN, a memory 20, processing circuitry 22, communications circuitry 24, and optionally a user input device 26. The communications circuitry 24 enables wired and/or wireless communication with other devices such as the one or more lighting fixtures 12 and the environmental control system 16 of FIG. 1. Accordingly, the communications circuitry 24 may have multiple communications interfaces such as a first type of communications interface to communicate with the one or more lighting fixtures 12 and a second type of communications interface to communicate with the environmental control system 16 and/or a user (e.g., via the user input device 26, which may be a touch input display). The memory 20 stores instructions, which, when executed by the processing circuitry 22 cause the ILM 14 to perform one or more functions, such as providing ambient environmental data (received form the one or more sensors S1-SN) and/or diagnostic information for the environmental control system 16 as discussed in detail below.

FIG. 2B is a schematic diagram of an exemplary embodiment of the ILM 14. The ILM 14 has a housing H in or on which sensors S1, S2, and S3 and the electronics described above are mounted. In this particular, but non-limiting, embodiment, sensor S1 is an ambient light sensor, sensor S2 is an occupancy sensor, and sensor S3 is an environmental sensor (e.g., one configured to measure ambient air temperature, air pressure, humidity, and/or air quality) mounted behind three openings that are provided in the housing H.

FIG. 2C is a schematic diagram of another exemplary embodiment of the ILM 14. FIG. 2C illustrates another sensor configuration for the ILM 14 that includes an image sensor S4, a vibration sensor S5, and a microphone S6, wherein the image sensor S4 may be configured and used to monitor ambient light, detect occupancy, recognize people or objects, and the like. Other embodiments may include more or fewer sensors, such as more or fewer ambient environmental sensors (e.g., the sensor S3 of FIG. 2B may be a combination environmental sensor, or several sensors may measure ambient environmental conditions).

In some examples, the housing H of the ILM 14 is configured to releasably engage a compatible cradle (not shown) or the like such that the ILM 14 can be installed in a lighting fixture 12, a wall switch, a lighting network coordinator, or the like in a snap-fit or other appropriate manner. In some examples, the ILM 14 may be provided as a stand-alone device. As illustrated in FIGS. 2B and 2C, the housing H may include two front tabs 28 that extend outward from a bottom portion of the front wall of the housing H. Further, opposing side tabs 30 extend outward from bottom portions of opposing side walls of the housing H. The side tabs 30 are biased toward the rear wall of the housing H to engage with a cradle. It should be understood that this releasable configuration is illustrative in nature, and other embodiments may be installed in another appropriate manner.

FIG. 2D is a schematic diagram of another exemplary embodiment of the ILM 14. In some embodiments, the ILM 14 is a SmartCast™ Wireless Integration Module (WIM) produced by Cree Lighting of Durham, N.C. The ILM 14 includes an ambient light sensor S1, a passive infrared (PIR) occupancy sensor S2, and a user input device 26 (e.g., a reset button). The housing H of the ILM 14 further includes device attachment features 32 for snap-fit attachment to a lighting fixture or other lighting device and facia attachment features 34 for snap-fit attachment of a front facia where needed. In addition, the ILM 14 includes an ILM connector 36 (e.g., a digital addressable lighting interface (DALI) connection) for connection to a lighting fixture 12 and/or other components of an intelligent lighting network 10.

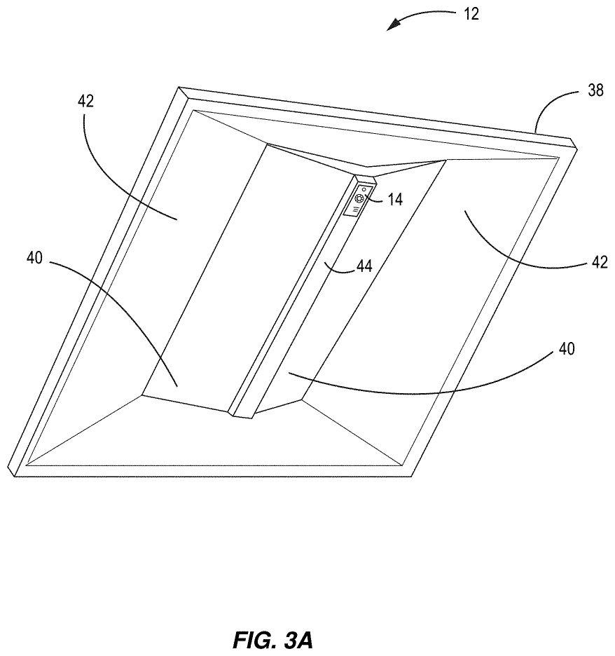

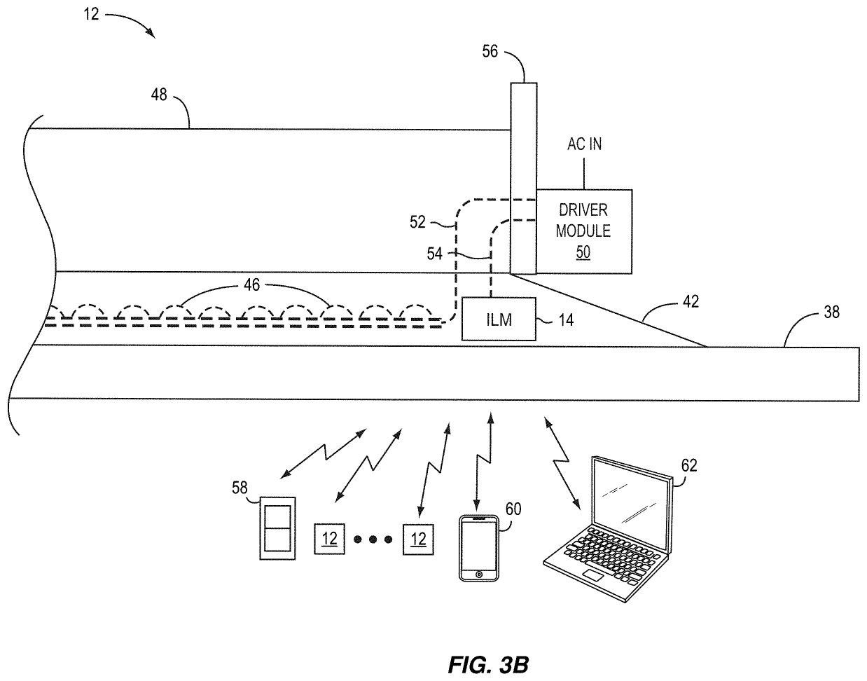

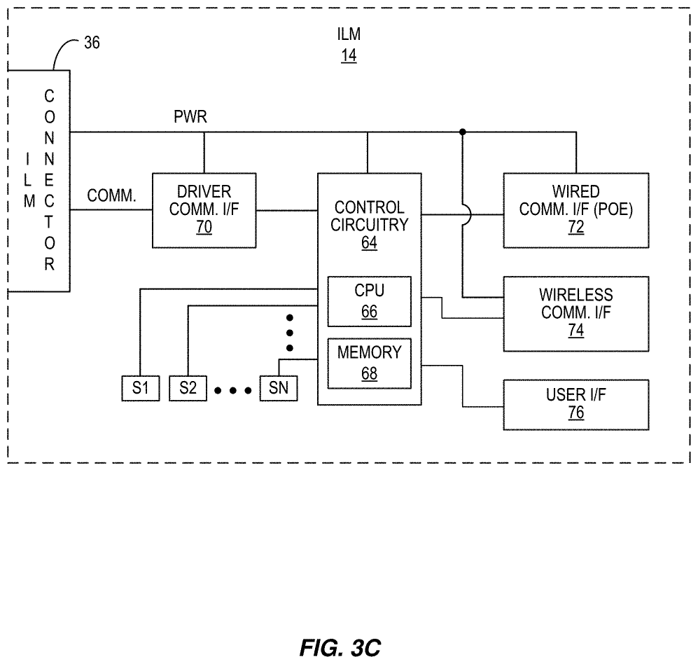

FIG. 3A is a schematic diagram of an exemplary installation of the ILM 14 in a lighting fixture 12. As described above, the ILM 14 may be installed in an interior or exterior space in the lighting fixture 12, in another device of the intelligent lighting network 10 of FIG. 1, or as a stand-alone device. While the concepts of the present disclosure may be employed in any type of lighting system, the immediately following description describes these concepts in a troffer-type lighting fixture, such as the lighting fixture 12 illustrated in FIG. 3A.

In general, troffer-type lighting fixtures, such as the lighting fixture 12, are designed to mount in, on, or from a ceiling. In most applications, the troffer-type lighting fixtures are mounted into a drop ceiling (not shown) of a commercial, educational, or governmental facility. As illustrated in FIG. 3A, the lighting fixture 12 includes a square or rectangular outer frame 38 (in other examples, the outer frame 38 may be any shape, such as circular, ovular, polygonal, etc.). In the central portion of the lighting fixture 12 are two rectangular lenses 40, which are generally transparent, translucent, or opaque. Reflectors 42 extend from the outer frame 38 to the outer edges of the lenses 40. The lenses 40 effectively extend between the innermost portions of the reflectors 42 to a central mounting member 44, which may double as a heatsink and functions in this embodiment to join the two inside edges of the lenses 40.

The ILM 14 may be mounted in, on, or to the central mounting member 44 or any other suitable portion of the lighting fixture 12. In some embodiments, the ILM 14 provides intelligence for the lighting fixture 12, houses one or more sensors, and facilitates wired and/or wireless communications with other lighting fixtures 12, networking entities, control entities, and the like. The communications with other lighting fixtures 12 may relate to sharing state information and sensor information, as well as providing instructions or other information that aids in the control of the lighting fixtures 12 individually or as a group during normal operation or commissioning. In addition, the ILM 14 provides ambient environmental data and/or diagnostic information for the environmental control system 16 as described further below.

FIG. 3B is a cross-sectional schematic diagram of the lighting fixture 12 of FIG. 3A. The lighting fixture 12 houses a light source 46, which may be a solid-state light source. In an exemplary aspect, the light source 46 is an LED array oriented to primarily emit light upwards toward a concave cover 48 and reflected toward the lenses 40. Those skilled in the art will recognize that the type of lenses 40, the type of LEDs, the shape of the cover 48, and any coating on the bottom side of the cover 48, among many other variables, will affect the quantity and quality of light emitted by the lighting fixture 12. The light source 46 may include LEDs of different colors, wherein the light emitted from the various LEDs mixes together to form a white light having a desired characteristic, such as spectral content (color or color temperature), color rendering index (CRI), output level, and the like based on the design parameters for the particular embodiment, environmental conditions, or the like.

A driver module 50 is coupled to the light source 46 (e.g., the LED array) and the ILM 14 through appropriate cabling 52, 54 and is mounted to a driver mount 56 of the lighting fixture 12. The driver module 50 is used to drive the light source 46 to provide a desired light output level in response to instructions from the ILM 14. In an exemplary aspect, the ILM 14 uses its internal logic to determine an on/off state and an output level based on information received from one or more of the integrated sensors, other lighting fixtures 12, and/or remote entities, such as wall controllers 58, mobile terminals 60, personal computers 62, and the like. The integrated sensors may include one or more ambient light, occupancy (motion), sound, temperature, humidity, pressure, vibration, carbon monoxide, carbon dioxide, air quality, smoke, image, power, or like sensors.

The ILM 14 may also send information bearing on the state of the lighting fixture 12, sensor measurements, and the like to one or more of the other lighting fixtures 12, and/or remote entities, such as the wall controllers 58, the mobile terminals 60, personal computers 62, and the like. The ILM 14 may also send control information that is configured to cause other lighting fixtures 12, or groups thereof, to turn on, turn off, or transition to a desired light output level. As such, the lighting fixtures 12 may communicate with one another to share sensor measurements and state information, such that desired groups of lighting fixtures 12 act in unison in response to sensed environmental conditions, state information, sensor measurements or instructions from other lighting fixtures 12 or control entities, or a combination thereof.

FIG. 3C is a block diagram illustrating details of the ILM 14 according to another embodiment of the present disclosure. The ILM 14 includes control circuitry 64 having an associated central processing unit (CPU) 66 and memory 68, which contains the requisite software instructions and data to facilitate operation as described herein. The control circuitry 64 may be associated with a driver communication interface 70, which is to be coupled to the driver module 50, directly or indirectly via an ILM connector 36. The control circuitry 64 may be associated with a wired communication interface 72, a wireless communication interface 74, or both, to facilitate wired or wireless communications with other lighting fixtures 12, and/or remote entities, such as wall controllers 58, mobile terminals 60, personal computers 62, and the like. The wireless communication interface 74 may include the requisite transceiver electronics to facilitate wireless communications with remote entities using any number of wireless communication protocols. The wired communication interface 72 may support DALI, universal serial (USB), ethernet, or like interfaces using any number of wired communication protocols.

In one embodiment, the ILM 14 may receive power in the form of a DC signal from the driver module 50 via the ILM connector 36 and facilitate communications with the driver module 50 via the driver communication interface 70 and the ILM connector 36. Communications with other lighting fixtures 12 and/or remote entities, such as wall controllers 58, mobile terminals 60, personal computers 62, and the like are facilitated via the wired or wireless communication interfaces 72, 74.

In an alternative embodiment, the ILM 14 will receive power in the form of a DC power signal via the wired communication interface 72, which may be configured as a powered DALI interface or a power over ethernet (PoE) interface. The DC power signal received via the wired communication interface 72 is used to power the electronics of the ILM 14 and is passed to the driver module 50 via the ILM connector 36. The driver module 50 will use the DC power signal to power the electronics of the driver module 50 and drive the light source 46. Communications with other lighting fixtures 12 and/or remote entities, such as wall controllers 58, personal computers 62, and the like are facilitated via the wired communication interface 72. The ILM 14 will facilitate communications with the driver module 50 via the driver communication interface 70 and the ILM connector 36.

As described above, the ILM 14 includes multiple integrated sensors S1-SN, which are directly or indirectly coupled to the control circuitry 64. The sensors S1-SN may include one or more ambient light, occupancy (motion), sound, temperature, humidity, pressure, vibration, carbon monoxide, carbon dioxide, air quality, smoke, power, image, or like sensors. The sensors S1-SN provide sensor data (including ambient environmental data) to the control circuitry 64. According to embodiments described herein, the ILM 14 collects ambient environmental data from the sensors S1-SN, and may further perform a diagnostic of the environmental control system 16 based on the ambient environmental data. In some embodiments, the ILM 14 collects and forwards the ambient environmental data to other processing circuitry for analysis and performing the diagnostic.

In some embodiments, the ILM 14 will determine how the driver module 50 should drive the light source 46 based on the sensor data and any other data or instructions received from remote entities, such as other lighting fixtures 12, wall controllers 58, mobile terminals 60, personal computers 62, and the like. Based on how the driver module 50 should drive the light source 46, the ILM 14 will generate and send appropriate instructions to the driver module 50 via the driver communication interface 70 and the ILM connector 36. The driver module 50 will drive the light source 46 based on the instructions received from the ILM 14. These instructions may result in the driver module 50 turning off the light source 46, turning on the light source 46 to a certain light output level, changing the light output level provided by the light source 46, changing the color or correlated color temperature (CCT) of the light output, and the like.

In addition to controlling the driver module 50 to control the light output of the light source 46, the ILM 14 may play an important role in coordinating intelligence and sharing data among the lighting fixtures 12 or other devices in the intelligent lighting network 10 and/or the additional network 18 of FIG. 1. In addition to receiving data and instructions from other lighting fixtures 12 or remote control entities and using such information to control the driver module 50, the ILM 14 may also provide instructions to other lighting fixtures 12 and remote control entities based on the sensor data from its integrated sensors S1-SN as well as the sensor data and instructions received from the other lighting fixtures 12 and remote control entities.

The ILM 14 may have a user interface 76 that provides information related to the state or operation of the ILM 14, allows a user to manually provide information to the ILM 14, or a combination thereof. As such, the user interface 76 may include an input mechanism, an output mechanism, or both. The input mechanism may include one or more of buttons, keys, keypads, touchscreens, microphones, light sensors, wireless protocol, or the like. The output mechanism may include one more LEDs, a display, an audio output (e.g., buzzer, speaker), or the like. For the purposes of this application, a button is defined to include a push button switch, all or part of a toggle switch, rotary dial, slider, or any other mechanical input mechanism.

II. Ambient Environmental Data and Environmental Control Systems

With continuing reference to FIGS. 1-3C, the ILMs 14 described herein, which can be embedded in lighting fixtures 12, zone controllers, wall controllers, and the like, collect very useful data (e.g., temperature, pressure, and/or relative humidity) for environmental control system 16 (e.g., HVAC system) diagnostics for several reasons. For example, the ILMs 14 have extensive reach across a given building as they can be embedded in any component of the intelligent lighting network 10 and share data within the intelligent lighting network 10 through wired or wireless communications. This results in far more granular environmental data compared to the reach of the primary sensors in HVAC systems. Each ILM 14 can act as a virtual extension sensor for the HVAC system.

In addition, the ILMs 14 offer the ability to monitor temperature and humidity with required resolution/accuracy to be able to see swings in the environmental data (e.g., due to HVAC cycles). This provides a lot of valuable information on the HVAC system's performance in any building and can be used for diagnosing problems and predicting/preventing future failures. Further, the ILMs 14 provide the ability to monitor differential pressure across different zones of a building. This provides a lot of valuable information on the HVAC system's performance and can be used for diagnosing problems and predicting/preventing future failures.

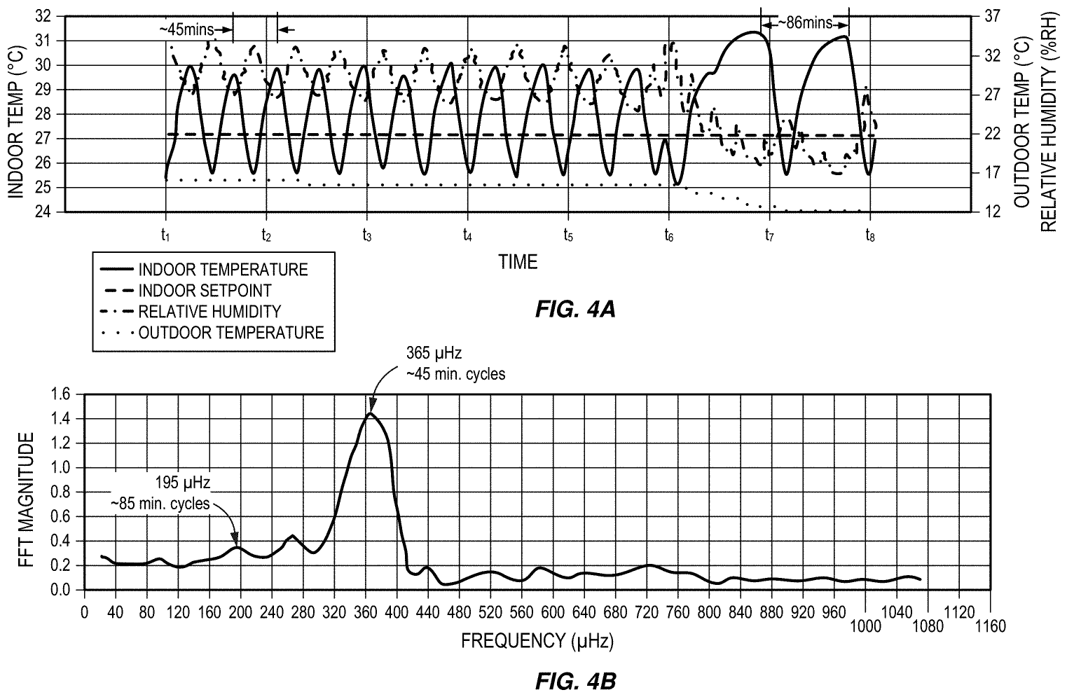

In this regard, FIG. 4A is a graphical representation of an example of temperature and relative humidity cycles collected by an ILM 14 in a closed room. In the illustrated example, the temperature and humidity data are collected from an ILM 14 installed in a ceiling mounted low-voltage zone controller installed in an 11 foot (ft)×13 ft room and a ceiling height of 10 ft with a closed door. This example is taken during winter and illustrates temperature and relative humidity swings that indicate the frequency of HVAC system cycles. Between times t₁ and t₆, the HVAC system cycles regularly. At time t₆, a power loss occurs, resulting in a reset of the hysteresis of the HVAC system and longer cycles between times t₆ and t₈ in response to a change of outdoor temperature.

FIG. 4B is a graphical representation of a fast Fourier transform (FFT) of the indoor temperature data of FIG. 4A. The FFT illustrates various frequencies in the temperature data which can be used for HVAC system diagnostics. As illustrated, the largest peak occurs at 365 microhertz (μHz), which corresponds to approximately 45-minute cycles. Another peak occurs at 195 μHz, which corresponds to approximately 85-minute cycles.

The temperature cycle data illustrated in FIGS. 4A and 4B is analogous to a human heartbeat. While a heartbeat rate is generally constant at rest, the heartbeat rate changes when a person is running, walking, has any breathing issues, and so on. There are different heartbeat rates that can be regarded as “normal” based on what the person is doing such as walking or running. A higher heartbeat is not necessarily a problem when the person is running, but if the heartbeat rate is high when the person is not running, it is indicative of some problem and a cardiologist can interpret and appreciate the heartbeat plot. Similarly, the temperature and relative humidity cycles in a room are indicative of whether an HVAC system is healthy or not, and embodiments of the present disclosure provide diagnostics of the HVAC system. Similar to a human heartbeat profile, this analysis may include several different “normals” depending on conditions such as outside ambient temperature, interior set temperature, whether active heating or cooling, size of room, thermal load, etc.

HVAC manufacturers typically have baseline data with HVAC operation, performance, efficiency etc. with several variables such as different outside air temperatures, different inside set temperatures, different area sizes, different loads, effect of clogged filter etc. Such data is unique to a specific HVAC system and is generally proprietary. Embodiments described herein analyze the environmental data gathered by ILMs 14 distributed in the intelligent lighting network 10 and function as a local clinic for environmental control systems for a number of operational conditions. Even in absence of baseline data from a manufacturer, embodiments can provide fundamental and specialized diagnoses based on temperature, pressure, and relative humidity data obtained from the ILMs 14.

In addition to diagnostics, embodiments described herein can predict and/or prevent failures from happening. Environmental data is collected by the ILMs 14 over time and analyzed to identify patterns, predict trends and/or gaps in optimizations, predict failures, and prevent such failures (e.g., with proper notifications or other appropriate actions). In some examples, a machine learning approach is applied to analyze the gathered environmental data (e.g., temperature, pressure, relative humidity, etc.) and provide diagnostics and optimizations.

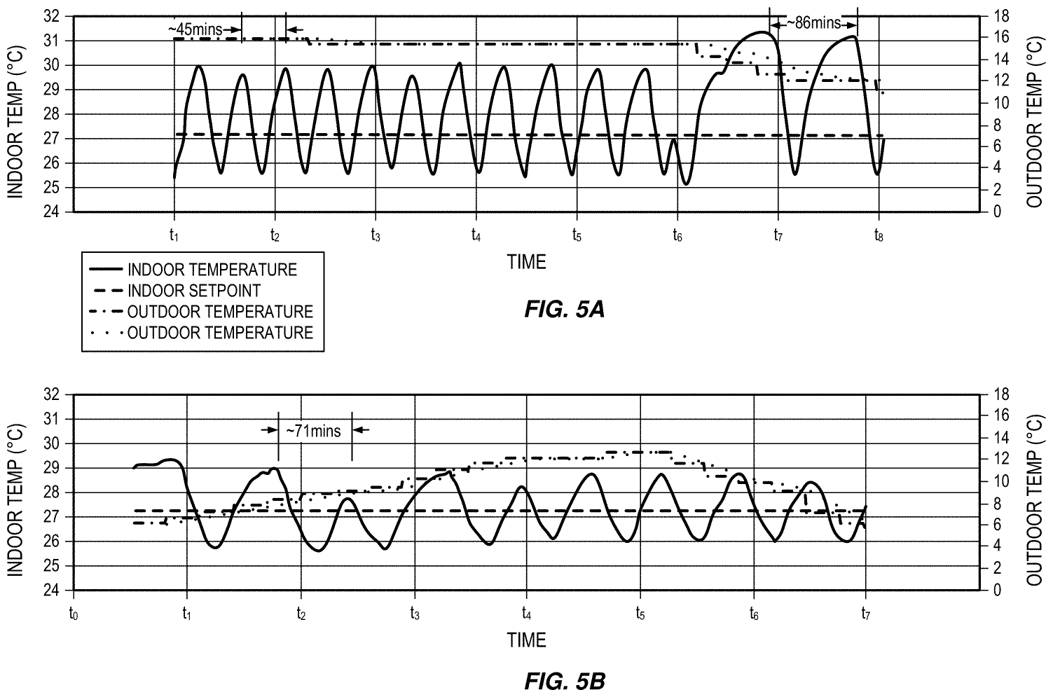

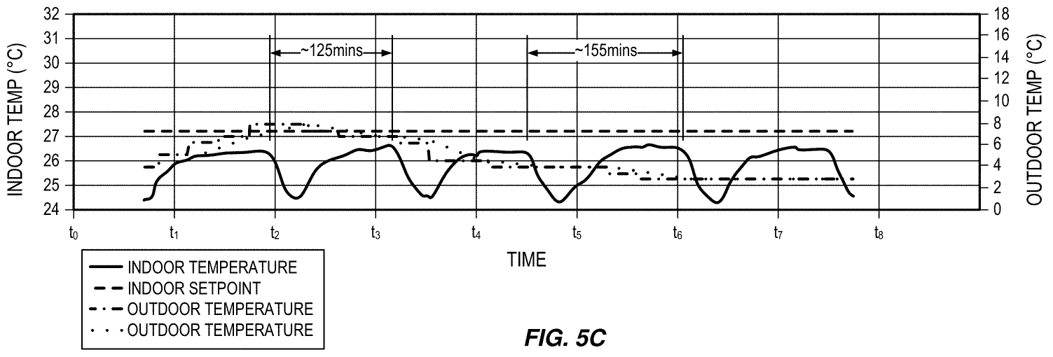

FIG. 5A is a graphical representation of an example of indoor temperature cycle durations on a relatively warmer winter day. FIG. 5B is a graphical representation of another example of indoor temperature cycle durations on a different winter day. FIG. 5C is a graphical representation of another example of indoor temperature cycle durations on a relatively colder winter day. All of the data of FIGS. 5A-5C is from the same room, same indoor set temperature, same thermal load in the room, where the main variable is outdoor temperature.

FIGS. 5A-5C show how indoor temperature cycle durations change with different outdoor temperatures over about 11 hours on 3 different days with the same indoor set temperature. When the outdoor temperature is relatively warmer for a winter day (FIG. 5A, with an average of 15.2° C.), the HVAC cycle durations are shorter. Conversely, when the outdoor temperature is colder (FIG. 5C, with an average of 3.9° C.), the HVAC cycle durations are longer.

A. Diagnostics Using Temperature Data from ILMs

Table 1 below provides an example of diagnostics of an environmental control system 16 that can be made using temperature data from ILMs 14 in the intelligent lighting network 10. It should be noted that how short or how long of a cycle indicates an operational issue, how much temperature swing indicates an operational issue, and so on are functions of the environmental control system 16 in the building, outside building temperature where heat exchange happens, indoor set temperature, size of the area, thermal load, etc. Accordingly, this disclosure does not define numeric limits for short or long cycles or swing sizes, but instead embodiments are configured to dynamically determine such limits and profiles based on historical data, user inputs, and other appropriate approaches.

TABLE 1

| SI. | | |
|---|---|---|
| No | Indicator | Potential Reasons/Diagnostics |
| 1 | Short duration temperature | Malfunctioning primary |
| | cycles | temperature sensor/s or too small |
| | Impacts: | thermostat dead band |
| | Excessive Starts and | Improper location of temperature |
| | stops of compressor or | sensors |
| | other electro-mechanical | Dirty coils, Electrical issues, Drain |
| | systems, may lead to | blockages, Clogged filter |
| | premature equipment | An oversized HVAC system |
| | failure | |
| | Poor Humidity control | |
| 2 | Long duration temperature | Low Refrigerant or leak (during |
| | cycles | summers), Low heat generation |
| | Impacts: | or malfunction or inefficient |
| | Excessive strain on | furnace (in winters), airflow |
| | compressor or other | problem or some other |
| | electro-mechanical | mechanical issue |
| | systems, may lead to | Ductwork improperly sized or |
| | premature equipment | sealed or damaged |
| | failure | Undersized HVAC system that is |
| | | likely unable to meet |
| | | heating/cooling demands of the |
| | | environment - Out of capacity or |
| | | near max capacity |
| 3 | Large temperature swings on | A large hysteresis resulting from |
| | cyclic temperature profiles | thermostat settings or a |
| | Impacts: | malfunctioning thermostat |
| | Poor temperature | Malfunctioning Variable Air |
| | regulation to the extent | Valves (VAVs) or their |
| | of being noticeable by | subsystems such as |
| | occupants leading to | dampers/heaters |
| | human discomfort | |
| 4 | No cycles or very feeble | A well-regulated space with small |
| | cycles with small | hysteresis (if smaller area) |
| | temperature swings and | A large open area with several |
| | close to temperature set- | supply air ducts and return air |
| | point | ducts collectively forming a |
| | | uniform temperature profile |
| | | across space (well-regulated |
| | | space) |

B. Diagnostics Using Pressure Data from ILMs

Table 2 below provides an example of diagnostics of an environmental control system 16 that can be made using pressure data from ILMs 14 in the intelligent lighting network 10. It should be noted that how much of a pressure delta indicates an operational issue is a function of the natural environmental pressure of a given geography and building construction as far as how well sealed or loosely sealed the interior space is (especially the ceiling), and even the rate of air flow from the HVAC system. For example, if delta pressure x in two adjacent rooms on the 20th floor of a building is regarded an issue, then x+Δx would be an equivalent issue at the 1st floor of the building. Accordingly, this disclosure does not define numeric limits for amounts of delta pressure, but instead embodiments are configured to dynamically determine such limits and profiles based on historical data, user inputs, and other appropriate approaches.

TABLE 2

| SI. | | Potential Reasons/ |
|---|---|---|
| No | Indicator | Diagnostics |
| 1 | Radically different pressures across | Imbalanced air supply and air |
| | different zones on the same floor | return indicating |
| | Impacts: | Damper malfunction |
| | Unintended positive or negative | Clogged filter |
| | pressures zone creation leading | Ductwork is improperly |
| | to improper door closures | sized or sealed or |
| | a harsh door slam that can | damaged |
| | cause injuries | Loss of refrigerant/ |
| | a door that never fully | malfunctioning furnace |
| | closes leading to wasted | leading to reduced |
| | energy | supply air flow |
| | Excessive strain on compressor | |
| | or other electro-mechanical | |
| | systems, may lead to premature | |
| | equipment failure or further | |
| | exacerbate the problem and | |
| | reduce heating/cooling capacity | |

C. Diagnostics Using Relative Humidity Data from ILMs

Table 3 below provides an example of diagnostics of an environmental control system 16 that can be made using relative humidity data from ILMs 14 in the intelligent lighting network 10. Most of the diagnoses provided by temperature data from ILMs 14 can also be done using relative humidity data as it shares the same or similar cycle information (e.g., short cycles, long cycles, etc.). The relative humidity data can be a second level check point for the diagnoses based on temperature data. Table 3 lists impacts of non-optimal relative humidity.

TABLE 3

| SI. | | |
|---|---|---|
| No | Indicator | Adverse effects |
| 1 | Low Relative | Human health |
| | Humidity | Hurts eyes, skin and respiratory tract |
| | | Promotes certain viruses to survive longer |
| 2 | Low Relative | Flammable materials storage/usage area |
| | Humidity | Low humidity promotes Static Electricity |
| | | → Fire hazard |
| 3 | Low Relative | Electronics Equipment - Static Electricity |
| | Humidity | sensitive areas |
| | | Low humidity promotes Static Electricity |
| | | → Damages/causes malfunction to |
| | | Electronics Equipment |

Averaged relative humidity data can also be used for general human health and catastrophe mitigation in areas of flammable material usage and protection to Electronics devices. Ideal relative humidity range with a general acceptance is 40% to 60%. The relative humidity data from the ILMs 14 can be used to optimize HVAC system performance. It should be understood that embodiments can perform additional diagnoses using combinations of temperature, pressure, relative humidity, and other environmental data.

III. Examples of HVAC Diagnostics Based on Data Gathered from ILMs

A. HVAC Diagnostics Example for Long Temperature Cycles

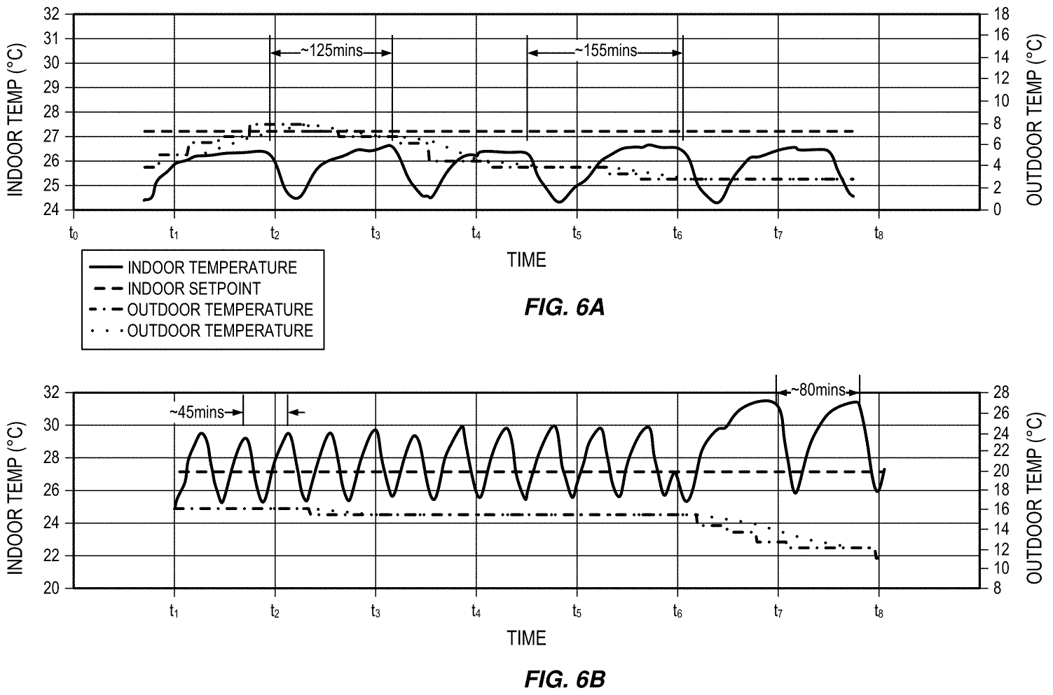

FIG. 6A is a graphical representation of an example of very long temperature cycles, indicating an undersized environmental control system 16. One could have suspected low refrigerant level if this was during summer but this data is on a winter day (it could also be furnace not generating enough heat, but not in this case as explained later). The plot of FIG. 6A shows the HVAC system struggle with long cycles (e.g., more than 2-hour cycles here, though what cycle length may be considered too long will vary in different embodiments) and yet not be able to attain the set temperature in the room—the HVAC system is forcefully cutting off the cycles.

FIG. 6B is a graphical representation of another example of long temperature cycles even in more favorable conditions in the same space as FIG. 6A. Looking at cycle durations on a relatively warmer winter day can further verify the diagnostic claim of being an undersized system. The illustrated plot shows shorter cycles (e.g., about 45-minute cycles here) on a day when the outside temperature is 16° C. (˜60° F.), which further indicates an undersized HVAC system for the space. It should be understood that FIGS. 6A and 6B provide an example of diagnostics of an HVAC system using temperature cycle lengths, but that the particular parameters may vary for different systems and user needs.

B. HVAC Diagnostics Example for Short Temperature Cycles

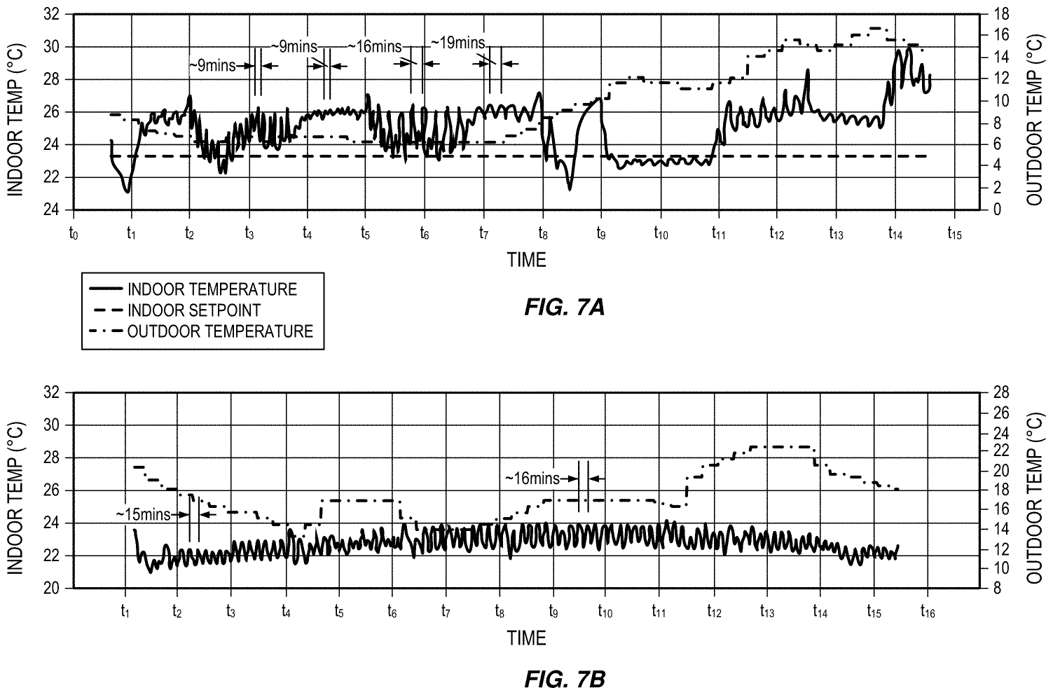

FIG. 7A is a graphical representation of an example of short temperature cycles, indicating a non-optimal environmental control system 16. This example shows erratic and varying short HVAC temperature cycles, where the HVAC system struggles to stay at set-point. In general, short periods indicate that the HVAC system is cycling ON and OFF too often due to a malfunctioning primary temperature sensor or too small thermostat dead band, an improperly located thermostat, dirty coils, electrical issues, drain blockages, clogged filter, or an oversized HVAC.

C. HVAC Diagnostics Example for Reasonable Temperature Cycles

FIG. 7B is a graphical representation of an example of relatively reasonable temperature cycles, indicating acceptable environmental control system 16 behavior. The plot shows about 4 cycles per hour, showing no signs of HVAC struggle and the room staying within reasonable temperature swing limits.

D. HVAC Diagnostics Example for Differential Pressure Measurement

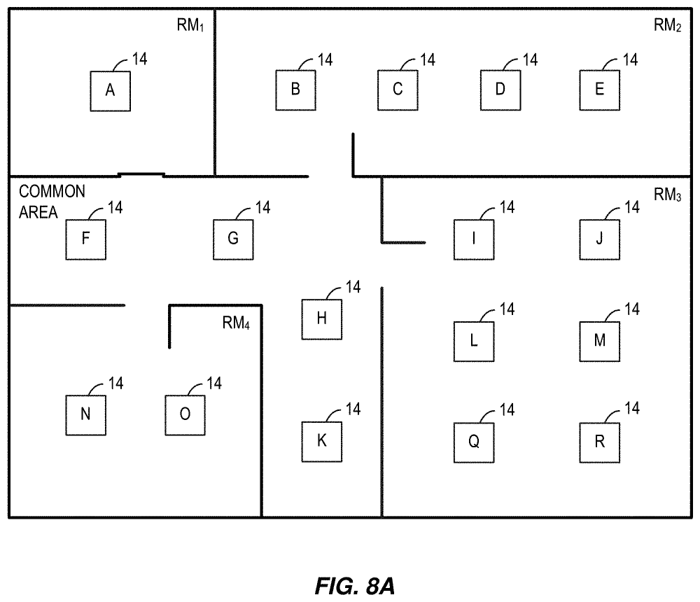

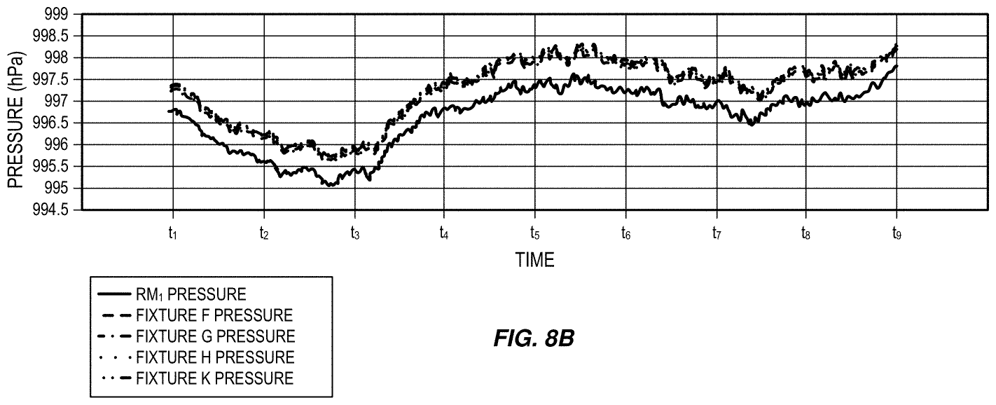

FIG. 8A is a schematic diagram of an example environment where environmental data is collected using ILMs 14 in lighting fixtures A-R. In this environment, lighting fixtures F, G, H, and K are in a common area and lighting fixture A is in room RM₁. Being on the same floor and mounted at the same height, the ILMs 14 in lighting fixtures A, F, G, H, and K are expected to measure the same pressure (within the sensors' tolerance). If the ILM 14 in lighting fixture A measures a pressure differential greater than a certain threshold compared to the ILMs 14 in the common area (in lighting fixtures F, G, H, K), this indicates that room RM₁ (with its door closed) has either positive or negative pressure, which is generally not desired. In some examples, a room and/or system may be intentionally designed to have positive or negative pressure, and diagnostics may measure whether sufficient pressure is being created according to design.

FIG. 8B is a graphical representation of pressures in the common area and room RM₁ in the environment of FIG. 8A. The pressure measurements directly indicate that the rate of air flow into the room and out of the room are not balanced. This implies one of the following: reduced air supply into room RM₁ (e.g., due to damper malfunction), compromised duct work (e.g., due to being improperly sized, sealed, or damaged), or blocked or reduced return air flow out of room RM₁ (e.g., due to a clogged filter). Specifically, in this example room RM₁ is at lower than expected pressure (negative pressure) implying supply air flow is much lower than return air flow, likely from a damper malfunction or compromised ductwork.

E. Temperature Data Gathered from the ILM Integrated into a Lighting Fixture

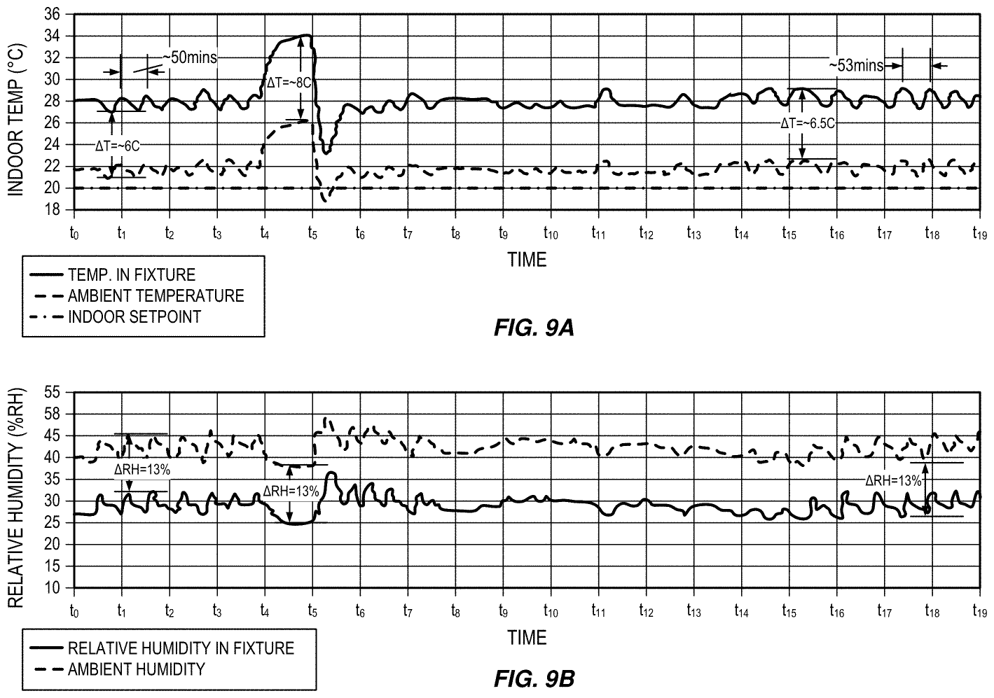

FIG. 9A is a graphical representation of temperature data gathered from an ILM 14 installed in a lighting fixture 12 compared with ambient temperature gathered from outside the lighting fixture 12. Even though the lighting fixtures 12 generate heat, the temperature data measured inside the lighting fixture 12 carries the HVAC diagnostic information. As illustrated, there is a relatively constant offset for the temperature data measured by the ILM 14 compared with ambient temperature outside the lighting fixture 12. Generally, this offset is a function of the lumen output of the lighting fixture, thermal mass, fixture efficiency, and mechanical construction. Embodiments of the present disclosure account for this offset with preprogramming (if known) or deduced using intelligent algorithms. For example, the ILM 14 may receive set-point data from the environmental control system 16 and use this in its analysis.

F. Relative Humidity Data Gathered from the ILM and Ambient Relative Humidity

FIG. 9B is a graphical representation of relative humidity data gathered from the ILM 14 of FIG. 9A compared with ambient relative humidity data gathered from outside the lighting fixture 12. Similar to the temperature data, relative humidity data gathered from the ILM 14 inside the lighting fixture 12 exhibits a relatively constant offset from the ambient relative humidity outside the lighting fixture 12. Temperature and humidity are generally inversely proportional (as temperature increases in the fixture, relative humidity decreases). Generally, this offset is a function of the lumen output of the lighting fixture 12, thermal mass, fixture efficiency, and mechanical construction. This offset can be preprogrammed if known or deduced using intelligent algorithms.

IV. Process for Environmental Control System Diagnostics and Optimization

Raw environmental data (e.g., temperature, pressure, and/or relative humidity data) from the ILMs 14 can be analyzed locally or remotely by including necessary analysis hardware. In some examples, the processed data is sent to a gateway or hub which in turn is BACnet enabled to communicate with HVAC controls. In some examples, the analysis is performed by a gateway or hub that wired or wirelessly communicates with the ILMs 14 and which is BACnet enabled or similar to communicate with HVAC controls. In some examples, the environmental data can be sent directly to the HVAC control system from the ILM 14 (e.g., as raw or processed data). The ILM 14 or another processing device performing the analysis can receive additional data, such as outside temperature data from additional sensors or through a network connection. This additional data can facilitate more refined and accurate diagnostics of environmental control systems 16.

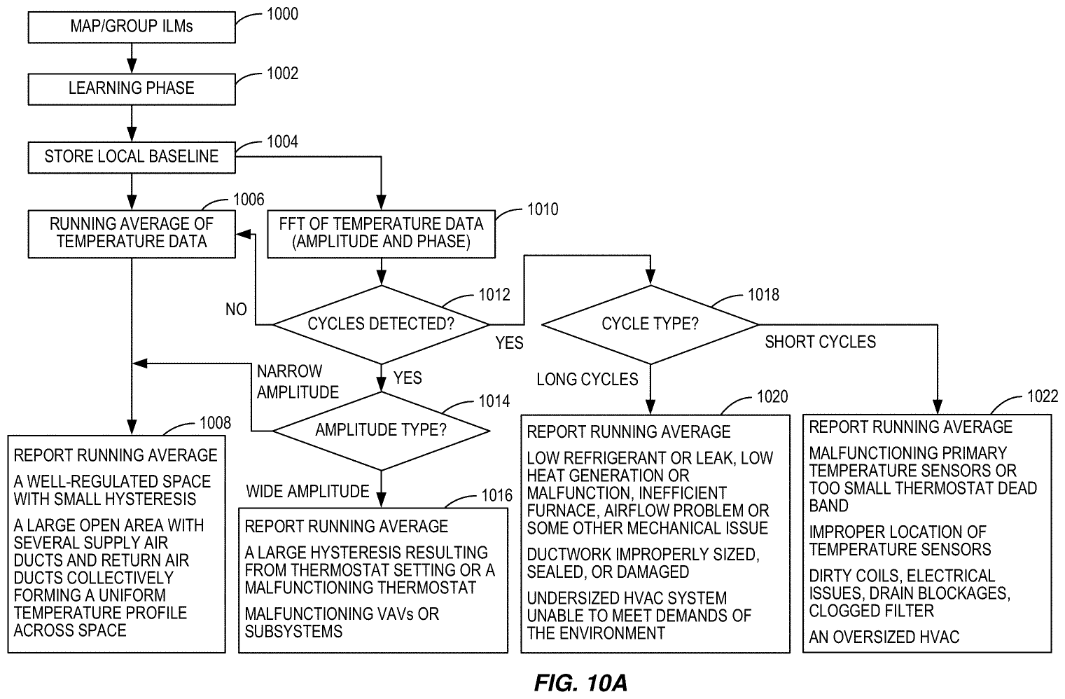

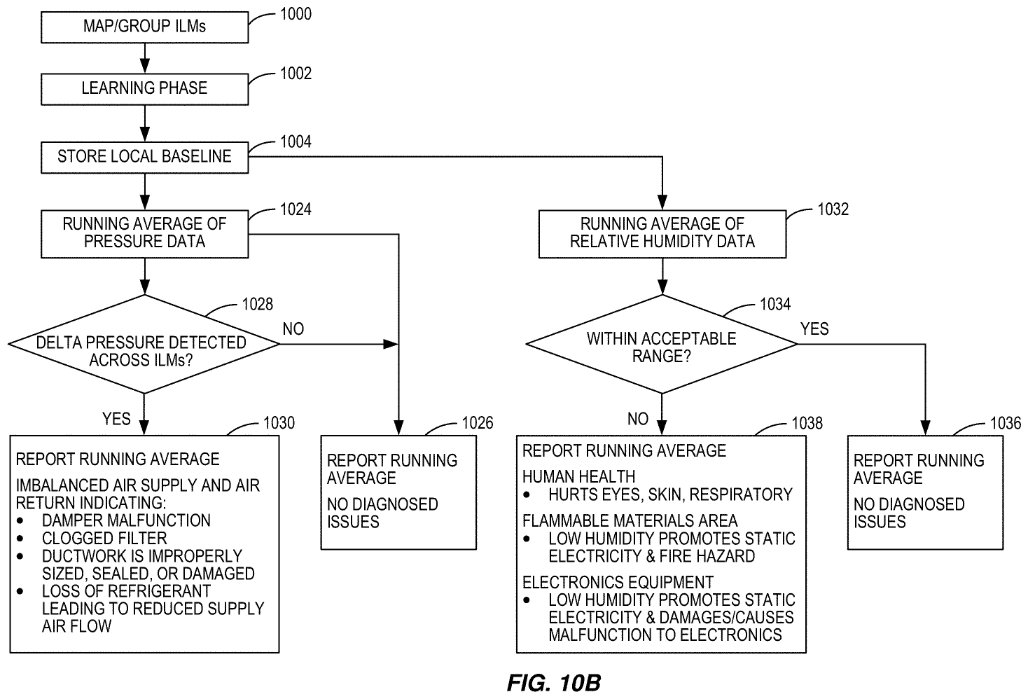

FIGS. 10A and 10B together are a flow diagram illustrating a process for environmental control system 16 diagnostics and optimization according to embodiments described herein. This process may be performed by the ILM 14, or by another processing device in communication with the ILM 14. The process can include some or all of the steps illustrated in FIGS. 10A and 10B.

In this regard, the process may begin at step 1000, where ILMs 14 in an environment are mapped, and may also be grouped according to zones, rooms, and so on (e.g., floor 1 walkway, floor 2 office 2, floor 3 conference room). This mapping may be performed automatically or with user input, or it may be preprogrammed. The process may continue at step 1002, a learning phase where the ILM 14 or another processing device accumulates environmental data for a period of time. From the learning phase or from preprogramming, a local baseline is stored at step 1004. With the local baseline stored, realtime data gathering begins.

At step 1006, a running average of raw temperature data can be gathered for further processing. This running average is reported (e.g., with necessary offset incorporated, such as if the ILM 14 is incorporated in a lighting fixture 12) to the environmental control system 16 and/or a user at step 1008 (e.g., this may be continuously reported). In parallel with the running average of raw temperature data, an FFT of the raw temperature data is performed, and its amplitude and phase are tracked and analyzed at step 1010. From the FFT, cycles of the environmental control system 16 may be detected at step 1012. If cycles are not detected, the process returns to collecting the running average of raw temperature data at step 1006.

If cycles are detected, an amplitude of the cycles is determined at step 1014. If a small amplitude of the cycles is detected, the process continues to step 1008, and may further indicate that the space is well-regulated with a small hysteresis. At step 1008, the process may in some examples indicate that the space is a large open area with several supply air ducts and return air ducts collectively forming a uniform temperature profile across the space. If a large amplitude of the cycles is detected at step 1014, the process may continue to step 1016, in which the running average is reported (e.g., with necessary offset incorporated). At step 1016, the process may further indicate a large hysteresis resulting from the thermostat setting or a malfunctioning thermostat, and in some examples may indicate malfunctioning variable air volume units (VAVs) or subsystems.

In addition, if cycles are detected at step 1012, a cycle type may be determined at step 1018. If long duration cycles are detected, the process may continue to step 1020, in which the running average is reported (e.g., with necessary offset incorporated). At step 1020, the process may further indicate low refrigerant or a leak in the system, low heat generation or malfunction, an inefficient furnace, an airflow problem, or some other mechanical issue. In some examples, at step 1020 the process may indicate ductwork is improperly sized, sealed, or damaged, or may indicate an undersized HVAC system unable to meet the demands of the environment.

If short duration cycles are detected at step 1018, the process may continue to step 1022, in which the running average is reported (e.g., with necessary offset incorporated). At step 1022, the process may further indicate malfunctioning primary temperature sensors or a thermostat with a too small dead band, improper location of temperature sensors, dirty coils, electrical issues, drain blockages, a clogged filter, or an oversized HVAC system.

At step 1024, a running average of raw pressure data can be gathered for further processing. This running average is reported to the environmental control system 16 and/or a user at step 1026 (e.g., this may be continuously reported). From the running average of pressure data, a delta pressure across ILMs 14 may be detected at step 1028. If a delta pressure is not detected, the process continues to step 1026, and may further indicate that no issues are diagnosed. If a delta pressure is detected, the process continues to step 1030, in which the running average is reported. At step 1030, the process may further indicate an imbalanced air supply and air return, which may indicate a damper malfunction, a clogged filter, ductwork that is improperly sized, sealed, or damaged, or loss of refrigerant leading to reduced supply air flow.

At step 1032, a running average of raw relative humidity data can be gathered for further processing. At step 1034, a determination is made whether the average relative humidity is within an acceptable range. If the relative humidity is acceptable, this running average is reported to the environmental control system 16 and/or a user at step 1036, and no issues are diagnosed. If the relative humidity is not acceptable, the process continues to step 1038, and may further indicate a human health issue, such as potential harm to eyes, skin, and respiratory systems. At step 1038, if in a flammable materials area the process may further indicate safety risk as low humidity promotes static electricity and a fire hazard. At step 1038, if in an area with electronics equipment the process may further indicate a static electricity damage risk as low humidity promotes static electricity and damages or causes malfunction in electronics.

With reference to each of the branches of FIGS. 10A and 10B, the analyzed environmental data (e.g., temperature, pressure, and/or relative humidity data) from the ILMs 14 can be used for environmental control system 16 optimizations. This may facilitate more end user comfort or otherwise improve performance. For example, a certain room in a building that is maintaining lower temperature than expected can report, through one or more ILMs 14, real time temperatures to the building HVAC system and the HVAC system can take corrective measures.

V. Monitoring Differential Measurements in Controlled Environments

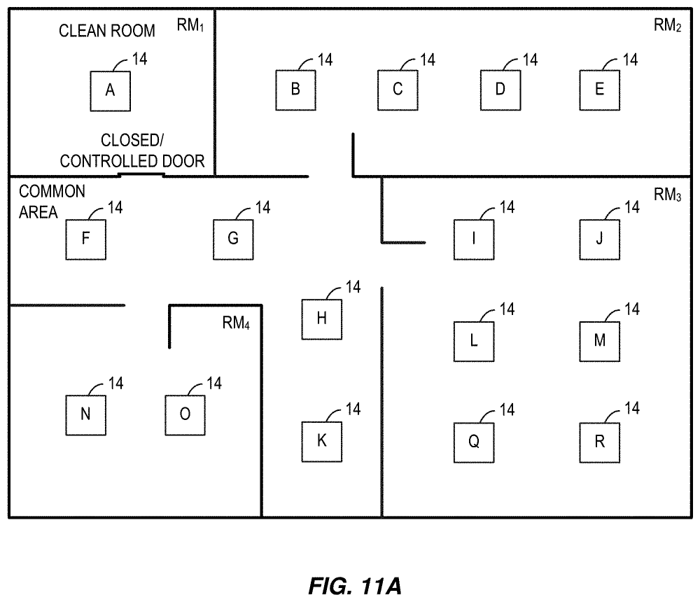

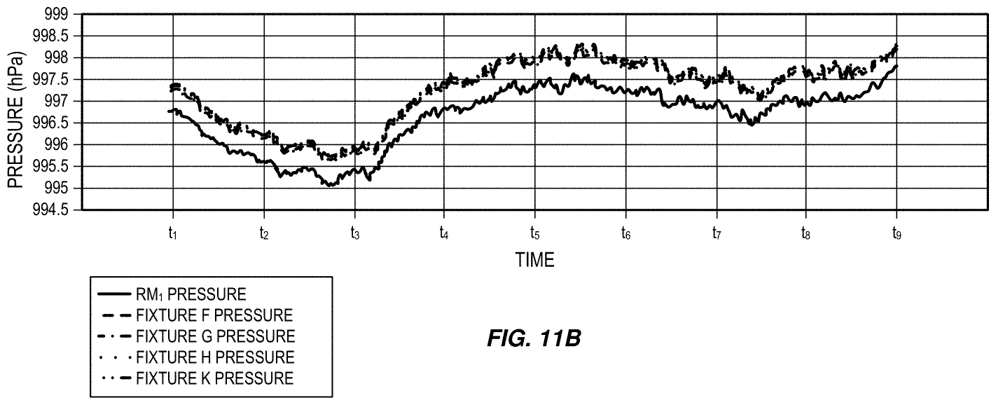

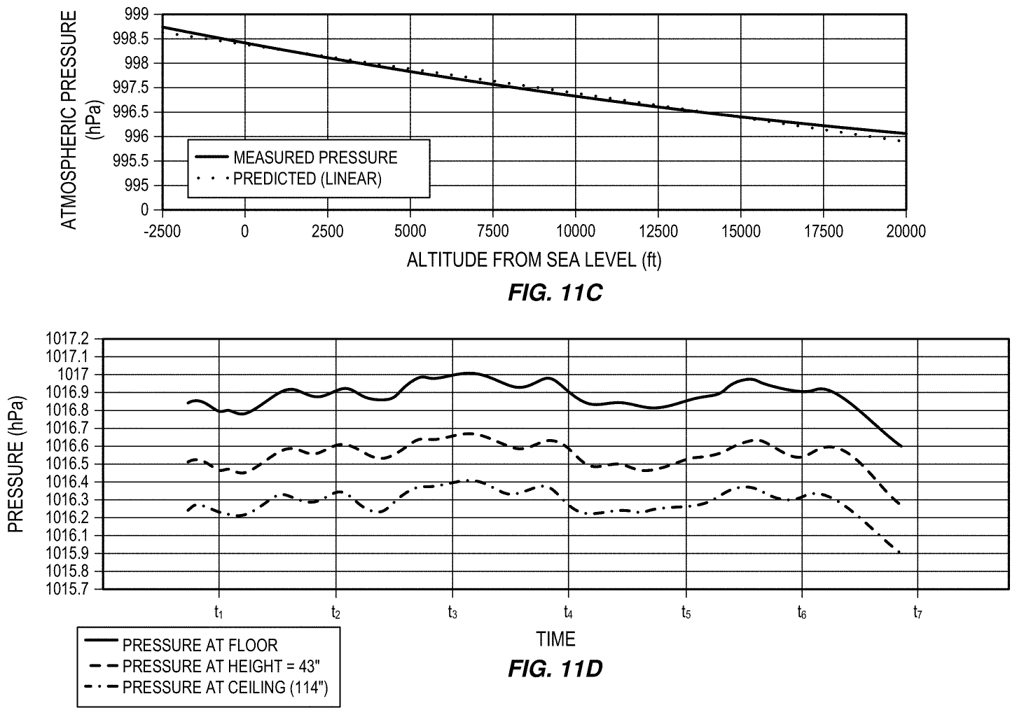

FIG. 11A is a schematic diagram of an exemplary controlled environment where environmental measurements are collected within and without the controlled environment using ILMs 14 in lighting fixtures A, F, G, H, and K. In this example, lighting fixture A is in a controlled environment (e.g., a clean room, a fabrication facility, a laboratory, etc.) in room RM₁, and lighting fixtures F, G, H, and K are in a common area outside the controlled environment. Being on the same floor and mounted at the same height, the ILMs 14 in lighting fixtures F, G, H, and K are expected to measure the same pressure or other controlled condition (within the sensors' tolerance) and the ILM 14 in lighting fixture A is expected to measure slightly lower or higher pressure depending on whether the controlled environment implements negative or positive pressure (e.g., the known pressure offset). It should be understood that while FIG. 11A illustrates the ILMs 14 in lighting fixtures, the ILMs 14 may additionally or alternatively be implemented in zone controllers or other devices in connected to the lighting network.

FIG. 11B is a graphical representation of pressures in the common area and room RM₁ in the environment of FIG. 11A. In the illustrated example, the clean room in room RM₁ maintains negative pressure. If the ILM 14 in lighting fixture A measures a pressure differential greater than a required threshold compared to the ILMs 14 in the common area (e.g., in lighting fixtures F, G, H, K), this indicates that the clean room is in a fault condition or out of compliance form the required standards. Embodiments may log, record, and/or report the monitored differential measurements as appropriate. For example, the differential measurements may be logged over time to provide compliance reporting. In other examples, faults may be recorded and/or an alert provided to a user. The differential measurements and/or fault information may further be provided to a control system for the controlled environment.

One aspect of embodiments monitoring differential measurements in controlled environments is fault reporting based on such differentials (e.g., based on delta pressure of a clean room). Accordingly, the installation location and particular device implementation of the ILMs 14 generally does not impact the monitoring so long as all networked products are subject to a common condition (e.g., in the case of pressure, where the ILMs 14 are mounted at a common height). Even if the ILMs 14 experience a difference in environmental conditions, embodiments may be able to account for those differences (e.g., by establishing baseline differences between ILMs 14). For example, even if ILMs 14 measuring pressure are not mounted at a common height, the baseline difference may be taken into account in monitoring pressure differentials. Other examples can account for other environmental conditions, such as humidity, temperature (e.g., due to heat sources/sinks), air composition (e.g., presence of particulate matter or gases), and so on.

FIG. 11C is a graphical representation of atmospheric pressure measurements as a function of altitude. As illustrated in FIG. 11C, atmospheric pressure has a linear relationship with elevation, and therefore ILMs 14 mounted at different heights will experience a predictable offset in pressure. In this regard, reliable delta pressure reporting can be done with simple offsets or curve fitting based on the known mounting heights of the ILMs 14. In such cases, a one-time setup or calibration can be performed at the time of installation and/or as a part of commissioning (periodically or otherwise as needed). In some embodiments, such a calibration may further involve modeling changes in the environmental data of different ILMs 14 from a calibrated baseline.

FIG. 11D is a graphical representation of atmospheric pressure measurements for three ILMs 14 at different mounting heights in a room. This illustrates how monitoring of differential pressure can be performed with fixtures mounted at dissimilar heights, as well as at similar heights. When some of the ILMs 14 being monitored are at different mounting heights, the pressure offset from that mounting height can be removed from the target measurement calculations.

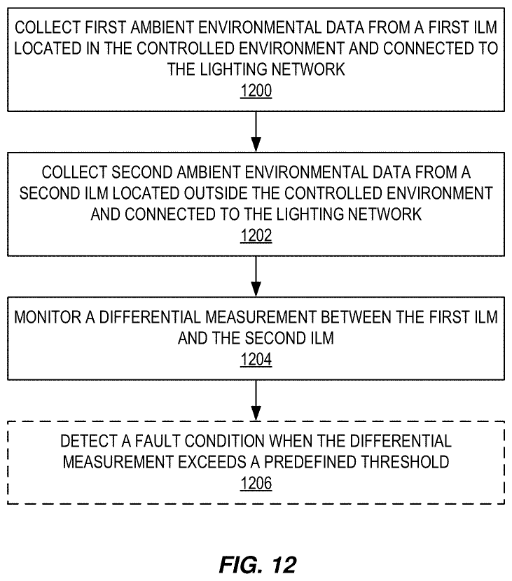

FIG. 12 is a flow diagram illustrating a process for monitoring differential measurements in a controlled environment using a lighting network. Dashed boxes represent optional steps. The process begins at operation 1200, with collecting first ambient environmental data from a first ILM located in the controlled environment and connected to the lighting network. The process continues at operation 1202, with collecting second ambient environmental data from a second ILM located outside the controlled environment and connected to the lighting network. The process continues at operation 1204, with monitoring a differential measurement between the first ILM and the second ILM. The process optionally continues at operation 1206, with detecting a fault condition when the differential measurement exceeds a predefined threshold.

Although the operations of FIG. 12 are illustrated in a series, this is for illustrative purposes and the operations are not necessarily order dependent. Some operations may be performed in a different order than that presented. Further, processes within the scope of this disclosure may include fewer or more steps than those illustrated in FIG. 12.

Those skilled in the art will recognize improvements and modifications to the preferred embodiments of the present disclosure. All such improvements and modifications are considered within the scope of the concepts disclosed herein and the claims that follow.

1. A method for providing diagnostic information for an environmental control system using a lighting network, the method comprising:
collecting ambient environmental data from an intelligent lighting module (ILM) in the lighting network; and
performing a diagnostic of the environmental control system based on the ambient environmental data.

2. The method of claim 1, further comprising providing diagnostic information from the diagnostic to the environmental control system.

3. The method of claim 1, further comprising providing diagnostic information from the diagnostic to a user interface device.

4. The method of claim 1, further comprising receiving control information from the environmental control system and using the control information in performing the diagnostic.

5. The method of claim 4, wherein the control information comprises a set-point of the environmental control system.

6. The method of claim 1, wherein the ambient environmental data is collected from a plurality of ILMs in the lighting network.

7. The method of claim 6, wherein:
the ambient environmental data comprises air pressure data; and
if the air pressure data comprises a differential pressure between two of the plurality of ILMs above a threshold, the diagnostic comprises an indication of an imbalanced air supply and air return.

8. The method of claim 1, wherein performing the diagnostic of the environmental control system comprises detecting cycles of the environmental control system from the ambient environmental data.

9. The method of claim 8, wherein:
the ambient environmental data comprises at least one of temperature data and relative humidity data; and
the cycles of the environmental control system are detected based on at least one of temperature cycles and relative humidity cycles in the at least one of temperature data and relative humidity data.

10. The method of claim 9, further comprising determining the temperature cycles from a fast Fourier transform of the temperature data.

11. The method of claim 8, wherein performing the diagnostic of the environmental control system further comprises determining a cycle duration of the environmental control system from the ambient environmental data.

12. The method of claim 11, wherein if the cycle duration is below a first threshold or above a second threshold, the diagnostic indicates a malfunction of the environmental control system.

13. A lighting system, comprising:
a lighting fixture;
an intelligent lighting module (ILM) comprising an environmental sensor; and
a processing device in communication with the ILM and configured to:
receive environmental data from the environmental sensor; and
analyze the environmental data to diagnose a potential failure of an environmental control system.

14. The lighting system of claim 13, wherein the ILM comprises the processing device.

15. The lighting system of claim 14, wherein:
the ILM is configured to generate an ILM instruction based on sensor data from at least one of the environmental sensor, an occupancy sensor, or an ambient light sensor; and
a driver module of the lighting fixture drives a light source based on the ILM instruction.

16. The lighting system of claim 13, wherein the processing device communicates with the ILM wired or wirelessly.

17. The lighting system of claim 13, wherein the processing device is configured to receive the environmental data from a plurality of ILMs, each ILM comprising an environmental sensor.

18. The lighting system of claim 13, wherein the environmental sensor comprises at least one of an ambient temperature sensor, a pressure sensor, or a relative humidity sensor.

19. An intelligent lighting module (ILM) for a lighting fixture that has a light source that outputs light for general illumination, the ILM comprising:
an environmental sensor configured to detect at least one of temperature data, pressure data, or humidity data;
processing circuitry configured to analyze at least one of the temperature data, the pressure data, or the humidity data to provide a diagnostic of an environmental control system; and
communications circuitry configured to send the diagnostic of the environmental control system to another device.

20. The ILM of claim 19, wherein the ILM is configured to be installed in at least one of a lighting fixture, a wall controller, or a zone controller of an intelligent lighting network.

21-40. (canceled)
